(19) United States
(12) Patent Application Publication
(10) Pub. No.: US 2017/0338859 A1
(43) Pub. Date: Nov. 23, 2017

(54) MODEM BASE STATION FOR WIRELESS CHARGING AT HOME OR OFFICE

(71) Applicant: Freddie Lee Figgers, Florida, FL (US)

(72) Inventor: Freddie Lee Figgers, Florida, FL (US)

(21) Appl. No.: 15/607,913

(22) Filed: May 30, 2017

Related U.S. Application Data
(60) Provisional application No. 62/456,171, filed on Feb. 8, 2017.

(51) Int. Cl. H04B 5/00; H02J 7/00; H02J 7/02; H02J 50/12

(52) U.S. Cl. CPC H04B 5/0037; H04B 5/0081; H02J 50/12; H02J 7/0027; H02J 7/025

(57) ABSTRACT

The present invention describes a modem based station for charging smartphones through wireless charging that is suitable for both home and, office purposes. When the modem based station is in the range of 5 meters from any cellular device, the cellular device automatically starts charging. The modem based station has to be charged from power source which can wirelessly charge more than one smartphones and it is compatible with all types of cellular phones. The modem based station works on the principle of inductive charging wherein it uses an electromagnetic field to transfer energy between the modem base station and the smartphone through electromagnetic induction. Energy or power from the modem base station to the smartphone is sent through an inductive coupling to an electrical device, which can then use that energy to charge or run the smartphone device.

### FIELD OF THE INVENTION

The present invention relates generally to wireless charging, and more specifically to devices, systems, and methods related to inductive charging that is used to charge the electronic devices automatically,

### BACKGROUND OF THE INVENTION

A wireless charging technique is a technique which enables the battery of an electronic device to be automatically charged without physically connecting it to a charger. Generally, devices such as electric shavers, electric toothbrushes etc., are charged using wireless techniques. The main advantage that is associated with the wireless charging technique is that it enables the electronic devices to be operated in water as well i.e. waterproof functionality. Another important feature of the wireless charging technique is that it is easy to carry as the wired charger is not required.

The wireless charging technique can be categorized into various types based on the mechanism of charging into electromagnetic induction type, wireless power transmission type and, resonance type of charging. The electromagnetic induction type of charging uses coils, a wireless power transmission type which converts electric energy into microwaves for transmission, and a resonance type which uses a resonance phenomenon. The wireless charging provides a convenient, safe, and reliable way to charge and power millions of electrical devices at home, in the workplace and in industry. Wireless charging eliminates the use of physical connectors and cables for charging purpose with high efficiency, cost and safety advantages over the traditional charging cable.

In recent days use of smartphones has increased highly that require charging facilities. For smartphones, charging phone using wireless power keeps the phone sale provides continuous, and reliable transfer of power to ensure all varieties of devices are charged and ready to use at any time.

In this digital age, almost all transactions are made using smartphones. Transactions starting from paying bills money transfer, banking and shopping, ordering food to booking travel tickets all are carried out through smartphones. This makes the smartphones highly useful and for carrying out all the transaction, it's the basic need to keep the smartphones charged all the time.

Currently most of the smartphones are charged using cable charger which has to be plugged in to the power source for a certain amount of time to charge the phones. There are several disadvantages of the cable chargers which include lack of more number of charging points on the go, always have to carry the chargers, chances of getting misplaced, not compatible with all type of smartphones and so on. All these inabilities of the cable charger, increases the need for the use of wireless chargers which has many advantages.

The currently available wireless chargers are not entirely wireless, because they still have to be plugged into a wall outlet, which frees the user from plugging-in the smartphone. For using such fast chargers, the smartphone has to, be placed on the pad, which charges the smartphone. But all the wireless chargers do not support all types of smartphones. Only some smartphones are compatible with the wireless chargers. For some smartphones to work, the users are required to buy special replacement back or a case that enables wireless charging.

The main disadvantage of such type of the wireless chargers is that it charges the smartphones when only placed on the charging pad. Another disadvantage of the wireless chargers is that only one smartphone can be charged at one time. Each battery powered device requires its own charger and power source, which is usually an AC power outlet. This becomes unwieldy when more than one devices need charging at same time.

Existing, designs of wireless chargers may perform best under a predefined orientation and deliver lower power levels if the orientation between the charger and the receiver is different. In addition, when the charged device is placed in a position where only a portion of the wireless power can be delivered to it, charging times may increase. The charging rate gradually decreases on time which increases the charging time.

Some solutions design the charger in a way that the user have to place the device in a special cradle or holder that positions the device to he charged in an advantageous orientation, which is less convenient than placing it in the charger without thought, or one that cannot hold multiple devices.

Many electronic devices are available in market which utilizes any power transmission techniques but the range of the power transmission technique is limited to only few electronic devices, such as electric shavers or electric toothbrushes, which works in short range. Also there are few wireless charging devices that can charge only single device at a time and also it has to be plugged in always along with the electronic device such as a smartphone he placed on the wireless charger.

Therefore there is a need for the development of a wireless chargers which can charge any number of smartphones in a range of distance through inductive charging.

### OBJECTIVES OF THE INVENTION

The primary objective of the present invention is to provide a wireless charging device in the form modem based station for home and office purposes.

Another objective of the present invention is to provide a wireless charging device that can automatically start charging from a five meter range.

Another objective of the present invention is to provide a wireless charging device which works on inductive charging principle.

### SUMMARY OF THE INVENTION

The main purpose of the present invention is to address the, problems associated with the existing products and to provide a solution to those issues. Accordingly, the present invention provides an apparatus for performing wireless charging of more than one electronic devices at same time.

The present invention provides an improved device for charging smartphones through wireless charging. The wireless charger has to he charged from power source which can wireless charge a number of smartphones.

The present invention is a modem based station that is suitable for both home and office purposes. The wireless charging device can charge more than one number of smartphones. Once the wireless charging device is in range of any cellular device, the cellular device or the smartphone automatically starts charging from a 5 meter range.

The present invention uses inductive charging system wherein the mains voltage is converted into high frequency alternating current (AC). The alternating current (AC) is then sent to the transmitter coil by the help of a transmitter circuit. The alternating current then induces a time varying magnetic field in the transmitter coil. The alternating current flowing within the transmitter coil induces a magnetic field which extends to the receiver coil (when within a specified distance). The magnetic field generates current within the receiver coil of the device. The process whereby energy is transmitted between the transmitter and receiver coil is also referred to as magnetic or resonant, coupling and is achieved by both coils, resonating at the same frequency. Current flowing within the receiver coil is converted into direct current (DC) by the receiver circuit, which can then he used to charge the battery. It is through this process that the power is safely transferred over an air gap.

The wireless charging device has to be connected to a power source and placed at any location inside home or office which connects wirelessly to the cellular devices or smartphones and charges them on the go when they enter the range. This enables the users to charge more than one device at the same time. Also the practice of placing the smartphone on the wireless charging device is completely eliminated.

### BRIEF DESCRIPTION OF THE DRAWINGS

FIG. 1 describes the modem base station which is used in wireless charging.

FIG. 2 describes the modem base station with antenna which is used in wireless charging.

FIG. 3 describes the wireless charging system used to charge the smartphones.

### DETAILED DESCRIPTION OF THE INVENTION

The present invention provides an improved wireless charging device for charging smartphones. The wireless charger consumes power from a power source to keep itself charged which in turn provides power for charging the specified number of smartphones at one time.

The present invention describes a modern based station model wireless charger that is suitable to use for both home and office purposes. The wireless charging device can he used to charge more than one smartphones.

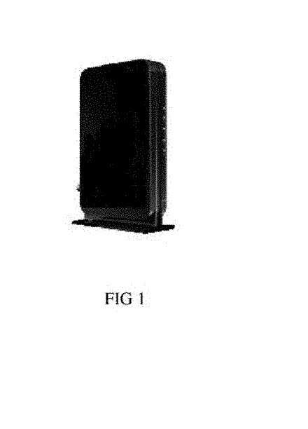

FIG. 1 describes the modem base station model through which wireless charging can be made. The model described comes without antenna that can span through a certain range. The modern base station serves as a relay which connects the electronic devices and the charging station together. The modern base station scans the area in the range to detect the smartphones and once the smartphones are detected, they are automatically connected to the modern bases station wirelessly. After connection is made., the power transmission takes place between the modem base station and the electronic devices i.e. smartphones. The batteries of the smartphones gets charged automatically when they are detected by the modem base station which enable the wireless charging of more than one electronic devices at same time.

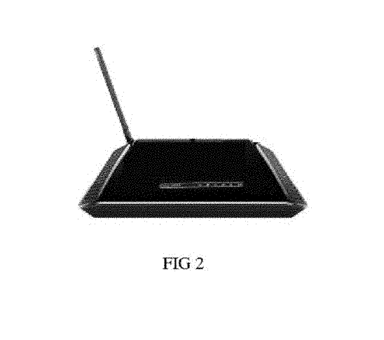

Referring to FIG. 2, a wireless modern base station is described which is used to carry out wireless charging. The model described comprises of an antenna which can through a certain range. Once the wireless charging base station is in range of 5 meters from any cellular device, the cellular device or the smartphone automatically starts charging.

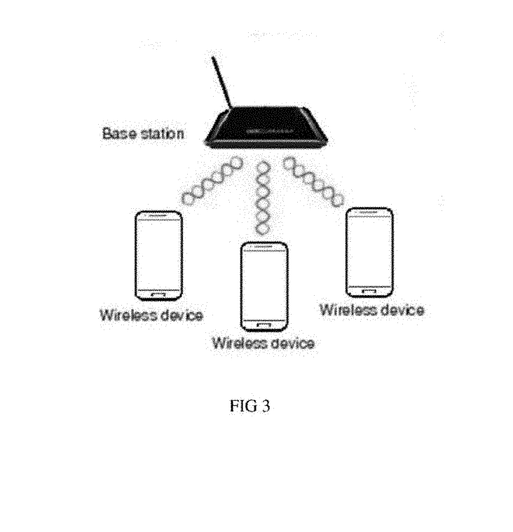

Referring to FIG. 3, the wireless charging system is described that shows the modem base station connected to the wireless devices or smartphones through wireless mode.

A modem base station comprises of a transmitter and a system wherein the transmitter comprises of a control unit, a communication unit and a power conversion unit. The system is connected control unit of the transmitter, wherein the control unit is connected to both the communication unit and power conversion unit. When the modern base station wirelessly connects to the smartphone, the inductive charging takes place which charges the smartphone wirelessly. The power conversion unit present in the modem base station uses the electromagnetic field to initiate the charging of the electronic devices. The smartphones which contains the batteries which gets charged by receiving power from the receiver unit.

The two parts present in the wireless charging system includes a modern base station and the:electronic device. i.e, the smartphone. The modem base station has a power transmitting unit which makes onward connection with the smartphone. As both the parts of the wireless charging unit comprises of induction coils which supports internal connections, the connection is made effortlessly without any human intervention. The power transfer and communication takes place through an inductive coil present in the base station.

The present invention works on the principle of inductive charging. Inductive charging uses an electromagnetic field to transfer energy between two objects through electromagnetic induction. This is carried out using a charging station. Energy or power from one device to other device is sent through an inductive coupling to an electrical device, which can then use that energy to charge or run the device.

Induction chargers use an induction coil to create an alternating electromagnetic field from within a base station, and a second induction coil in the wireless device takes power from the electromagnetic field and converts it back into electric current to charge the battery. The two induction coils in proximity combine to torn tin electrical transformer.

To achieve larger distance transfer between two devices, the inductive charging system uses resonant inductive coupling. The coils used in the inductive charging system can be made of silver plated copper or aluminum.

The present invention works on inductive charging system which is completed in six steps. In the first step, the mains voltage is converted into high frequency alternating current (AC). The second step comprises of sending the alternating current (AC) to the transmitter coil by the help of a transmitter circuit. In the third step, the alternating current induces a time varying magnetic field in the transmitter coil. In the fourth step, the alternating current flowing within the transmitter coil induces a magnetic field which extends to the receiver coil when the device is within a specified distance. In the fifth step, the magnetic field generates current within the receiver coil of the device and in the sixth step, the current flowing within the receiver coil is converted into direct current (DC) by the receiver circuit which can then be used to charge the battery of the smartphone.

The main advantage of the present invention is that it enables the users to charge more than one device at the same time.

Another advantage of the present invention is that, the charging of smartphones can be done in five meters range which is huge compared to present available systems.

Yet another advantage of the present invention is that, there is no need to place the smartphones on the wireless charging device in order to charge them.

Yet another advantage of the present invention is that, the wireless modem is compatible with all types of cell phones or smartphones which eliminates the requirement for buying separate charger for each phone.

Although the embodiments of the present invention have been disclosed for illustrative purposes, various modifications, additions and substitutions are possible, without departing from the scope and spirit of the invention as disclosed in the accompanying claims. Accordingly, the scope of the present invention should not be limited to the description of the embodiment, but defined by the accompanying claims and equivalents thereof.

1. A modem base station model which is used to charge the electronic devices through wireless charging feature.

2. A modem base station model as claimed in claim 1, wherein once the wireless charging base station is in range of 5 meters from any cellular device, the cellular device or the smartphone automatically starts charging.

3. A modem base station model as claimed in claim 1, wherein the modem base station uses inductive charging principle in which an electromagnetic field is created in order to transfer energy between two objects through electromagnetic induction.

4. A modem base station model as claimed in claim 3, wherein induction coils are used to create the electromagnetic field from within a base station and another induction coil in the wireless device takes power from the electromagnetic field and converts it back into electric current to charge the battery.

5. A modern base station model as claimed in claim 4, wherein the two induction coils which are used in proximity combine together to form an electrical transformer.

6. A modem base station model as claimed in claim 3, wherein in a resonant inductive coupling is used with the inductive charging system to achieve larger distance energy transfer between, two devices.

7. A modem base station model as claimed in claim 1, wherein the charging process takes place in six steps including,
a. The mains voltage is converted into high frequency alternating current (AC).
b. The alternating current (AC) is sent to the transmitter coil by help of a transmitter circuit.
c. The alternating current (AC) induces a time varying magnetic field in the transmitter coil.
d. The alternating current (AC) flowing within the transmitter coil induces a magnetic field which extends to the receiver coil when the device is within a specified distance.
e. The magnetic field generates current within the receiver coil of the device.
f. The current flowing within the receiver coil is converted into direct current (DC) the receiver circuit, which can then be used to charge the battery of the smartphone.

8. A modem base station model as claimed in claim 1, wherein the model of the modem can be with antenna or without antenna.

9. A modem base station model as claimed in claim 1, wherein the modem is can wirelessly charge more than one smartphones at same time.
